(19) United States
(12) Patent Application Publication
(10) Pub. No.: US 2025/0135253 A1
(43) Pub. Date: May 1, 2025

(54) FIRE SPRINKLER SYSTEM TRIP TESTER

(71) Applicant: Arbiter Incorporated, Washougal, WA (US)

(72) Inventors: Adolfo Jose Wurts, Fort Worth, TX (US); Demian Mendez, Camas, WA (US)

(21) Appl. No.: 18/927,843

(22) Filed: Oct. 25, 2024

Related U.S. Application Data
(60) Provisional application No. 63/593,281, filed on Oct. 26, 2023.

(51) Int. Cl. A62C 37/50

(52) U.S. Cl. CPC A62C 37/50

(57) ABSTRACT

A pressure probe measurement system is provided, comprising a pressure measurement device having a port configured to removably access and fluidly connect with a dry or wet portion of a fire sprinkler system, a pressure sensor fluidly connected to the port, and hardware configured to measure pressure in the fire sprinkler system and to monitor changes in the pressure in the fire sprinkler system, the hardware including a time keeping device and firmware and/or software that allows a fire sprinkler technician to determine times when key events occur in a trip test and/or full flow trip test of the fire sprinkler system. The system may include a controller configured to wirelessly communicate with the pressure measurement device and to permit the technician to display pressure in the fire sprinkler system and start and/or stop the time keeping device.

### CROSS-REFERENCE TO RELATED APPLICATIONS

This U.S. non-provisional patent application claims the benefit of U.S. provisional patent application Ser. No. 63/593,281 filed on Oct. 26, 2023, the entire contents of which is hereby incorporated by reference.

### BACKGROUND OF THE INVENTION

The technical field of invention relates to testing devices for measuring pressures and/or pressure changes and/or fluid flow changes associated with trip testing of fire sprinkler systems. More particularly, the present invention pertains to hand-held, single-hand-sized electronic test devices configured for use by, for example, a fire sprinkler system technician to perform a trip test and/or related periodic tests and inspections.

Several different types of fire sprinkler systems exist, each designed to protect lives and property by controlling or extinguishing fires in various structures such as residential, commercial, and industrial buildings, and structures such as parking garages. Sprinkler systems generally include a network of piping filled with pressurized water, with sprinkler heads that contain a heat-sensitive element that when triggered, for example by heat between 135-165 F, causing activation of the sprinkler head, letting pressure from the piping system flow from the activated head, or in the case of a deluge system, causing flow from all sprinkler heads in the system. Wet pipe sprinkler systems are the most common type, using sprinkler heads connected to pipes filled with pressurized water. When heat from a fire is detected, the sprinkler heads discharge water to contain or extinguish the fire. Such wet pipe systems do not work effectively in freezing cold environments, or in areas with water-sensitive equipment. For systems involving cold environments, or in areas that extend into areas where temperatures may fall below freezing, or in areas such as computer rooms and data centers which may contain water-sensitive equipment, dry pipe systems may be used. Dry pipe sprinkler systems use pressurized air or nitrogen in the pipes. A valve (such a clapper valve) prevents water from entering the pipes until the system is activated by a fire, at which point the pressure drops, the valve opens, and water flows through to extinguish the fire. Dry pipe systems typically require more maintenance and have higher installation costs; however, dry pipe fire sprinkler systems are more ideal for areas where freezing is a risk or for areas within which water intrusion could damage water-sensitive equipment. Pre-action sprinkler systems are similar to dry pipe systems in that they contain pressurized air or nitrogen in the pipes. Pre-action sprinkler systems use an electronic valve that requires both heat and smoke detection to release water. This dual-action mechanism provides an added layer of protection, which makes such systems more suitable for areas where accidental water discharge could cause significant damage. Foam water sprinkler systems combine water with a foam concentrate for large-scale fire suppression. Foam systems can be wet/wet pipe, dry/dry pipe, or pre-action in design, and include a bladder tank for containment of foam. When activated, the foam mixes with water to suppress and smother the fire, which makes foam systems more effective for protecting high-value assets such as, for example, aircraft, marine vessels/yachts, or motorized equipment.

Whether the fire sprinkler is a wet system, dry system, pre-action system, foam system, deluge system, etc., the system generally must abide by local building code regulations, and such (local) building code regulations typically align with NFPA 13, the National Fire Protection Association standard for the installation of fire sprinkler systems. NFPA 13 addresses accepted/best practices for fire sprinkler design approaches, system installation, and component selection options. Design considerations include building size and occupancies (i.e., assembly occupancies such as theaters or gathering places for more than 300 people, or business occupancies with office environments over 12000 square feet, or industrial occupancies such as factories over 12000 square feet or that involve storage of hazardous materials, or special hazard occupancies such as particular facilities with manufacturing, processing, or storing of flammable materials, or hi-rise buildings over 75 feet in height, or residential structures (of various sizes and configurations, or particular use case such as care facilities). The NFPA 13 standard, as cited herein, is incorporated in its entirety by reference.

The National Fire Protection Association, in addition to publishing the NFPA 13 standard for design and installation, further publishes the NFPA 25 standard for inspection, testing, and maintenance of water-based fire protection systems, which specifies weekly, monthly, quarterly, and annual inspection requirements. The annual tests and inspections generally require a licensed fire sprinkler system technician, due to the complexity of such fire sprinkler systems. The NFPA 25 provides detailed instructions for testing procedures, including, by way of general example: for sprinklers, hangers, pipes, and fittings—test such components to ensure they are in good working condition; for main drain tests—conduct tests on all sprinkler systems to verify control valves are open and functioning properly; for dry pipe valves—clean, reset, and perform a throttle trip test; for deluge valves—conduct a full trip test at least once a year if possible; for systems comprising an antifreeze solution—test the antifreeze solution chemistry and adjust the antifreeze solution in the systems if necessary; for nozzles on water spray systems—visually inspect and test the spray nozzles for proper flow; and for the system strainer—remove and visually inspect the system strainer for damage and replace any corroded components. Deluge and dry pipe valves can both be full flow trip tested. A “throttle trip test” is commonly referred to as a “partial trip test” or “partial flow trip test” or simply “trip test”. A trip test just ensures that the valve will trip. The “full flow trip test” or “full trip test” ensures that water reaches the test port and records the time that takes. The full flow trip test is less frequently done on dry systems. There is typically substantial cleaning and draining time involved with the full flow trip test. The NFPA 25 standard, as cited herein, is incorporated in its entirety by reference.

Testing and inspection of wet or dry systems generally include placement of an inspection tag. A typical inspection tag placed on a fire sprinkler riser valve, for example where the supply water is fed to the sprinkler network of pipes, may generally include check boxes and entry fields that the technician completes for certification of the testing and inspection results. Such tag generally includes the following system results: pass/fail (y/n), deficiencies/impairments (y/n), static water p.s.i. (value), residual water p.s.i. (value), did alarms operate (y/n), air pressure (value), air pressure trip point (value), trip time (seconds), water flow time (seconds), low points drained (y/n), anti-freeze point (y/n), water supply and valve left open (y/n), date of inspection and testing, license number of technician performing the inspection and testing, and initials of the technician.

Various testing methods have been published. For example, U.S. Pat. No. 9,205,293 (the '293 patent) (by Frederick H. Grenning), which is incorporated herein by reference, discloses a system and corresponding method for testing fire pumps installed in buildings that uses a sensor hub to gather measurement data from one or more pressure sensors installed in corresponding water conduits. The sensor hub broadcasts data related to water flow at the water conduit or conduits to a computer where the information from the sensors is converted to a total water flow through all water conduits. The total water flow is combined with other data about pump operation to determine whether the pump is operating within predetermined requirements. The computer may also analyze a photograph of a placard on the pump to determine model and other operating information from the pump. The '293 patents sets out to solve the problem with prior art systems for testing fire pumps requiring one person at the water outlet with a radio to set the water flow and then alert another person at the fire pump that the flow rate has reached a required level so that pump-related measurements may be taken by the other person. Alternatively, one person may set the water flow rate, assume that the rate will remain constant and then enter the building to record the fire pump data and return outside to turn off the water. The former method is costly in terms of manpower, and the latter is costly in terms of the extra water expended during the test, given that several thousand gallons of water a minute may be dumped into a street or storm drain. It is common for some tests to take 30 minutes or more resulting in very high water consumption during the testing. However, the '293 patent is directed to testing of fire pumps and not, in particular, to methods convenient and useful for a licensed fire sprinkler technician to use to perform the above-referenced NFPA 25 procedures for completion, for example of a trip test and filling out the typical system inspection tag.

Further, various hand-held devices have been designed. For example, U.S. Pat. No. 10,495,496 (the '496 patent) (by Marcial S. Villaverde), which is incorporated herein by reference, discloses systems and methods for measuring a flow rate through a nozzle include generating a first polynomial relationship between pressure and output voltage for a first pressure transducer located at one end of the nozzle and generating a second polynomial relationship between pressure and output voltage for a second pressure transducer located at another end of the nozzle. When a first voltage signal is received from the first pressure transducer and a second voltage signal from the second pressure transducer, the associated first and second pressures are generated based on the first and second polynomial relationships. A flow rate through the nozzle is then constructed based on the difference between the first pressure and the second pressure. However, the '496 patent is directed to measuring flow rate through a nozzle but fails to include features that would adequately assist a licensed fire sprinkler technician to perform the above-referenced NFPA 25 procedures for completion, for example of a trip test and filing out the typical system inspection tag.

What is needed are designs and methods for a hand-held, single-hand-sized testing device and/or system comprising one or more small, hand-held testing device and wirelessly coupled controller, configured for measuring fluid pressure and elapsed time and collect other data and parameters to perform a fire sprinkler system trip test, the above-referenced NFPA 25 procedures, and/or completion of the typical inspection tag for the fire sprinkler system, by a fire sprinkler system technician.

The foregoing and other objectives, features, and advantages of the invention will be more readily understood upon consideration of the following detailed description of the invention taken in conjunction with the accompanying drawings.

### BRIEF DESCRIPTION OF THE DRAWINGS

For a more complete understanding of the present invention, the drawings herein illustrate examples of the invention. The drawings, however, do not limit the scope of the invention. Similar references in the drawings indicate similar elements.

FIG. 1 is a schematic diagram of a fire sprinkler system trip tester comprising a pressure probe measurement system, according to embodiments.

FIG. 2 is a pressure measurement device of the pressure probe measurement system of FIG. 1, according to embodiments.

FIGS. 3-9 are exemplary screen shots of a graphical user interface, illustrating exemplary steps in a trip test sequence, according to embodiments.

### DETAILED DESCRIPTION

It is to be understood that the disclosure may assume various alternative orientations and step sequences, except where expressly specified to the contrary. It is also to be understood that the specific assemblies and systems illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

Trip testing of dry fire sprinkler systems is a yearly test that is required under the NFPA guidelines (such as NFPA 13 and NFPA 25) for fire sprinkler technicians. The present inventors determined that currently there are no systems for logging the necessary trip testing measurements and keeping records of them over time that are specifically built for trip testing a fire sprinkler system. The present inventors discovered and developed systems comprised of pressure probes that are capable of logging the measurements and then communicating them to a mobile device, directly or through a controller and ultimately to a database where they can be stored. Such systems also provide a potential for analysis of each individual system test as well as analyzing the fire sprinkler system under test compared to prior tests of that particular fire sprinkler system and/or other fire sprinkler systems tested. The present inventors determined that this sort of data acquisition and analysis has a potential to deepen the understanding of dry and pre-action fire sprinkler systems beyond what is known today.

Presently, the (NFPA guidelines) standard calls for two testers (i.e., two individual fire sprinkler technicians) to perform a trip test because it requires actions and monitoring at two different locations of the fire sprinkler system. The present inventors discovered and developed a hand-held measurement system that can monitor one of these locations so that the test can be performed accurately by one technician, thereby saving labor for the fire sprinkler technician monitoring company.

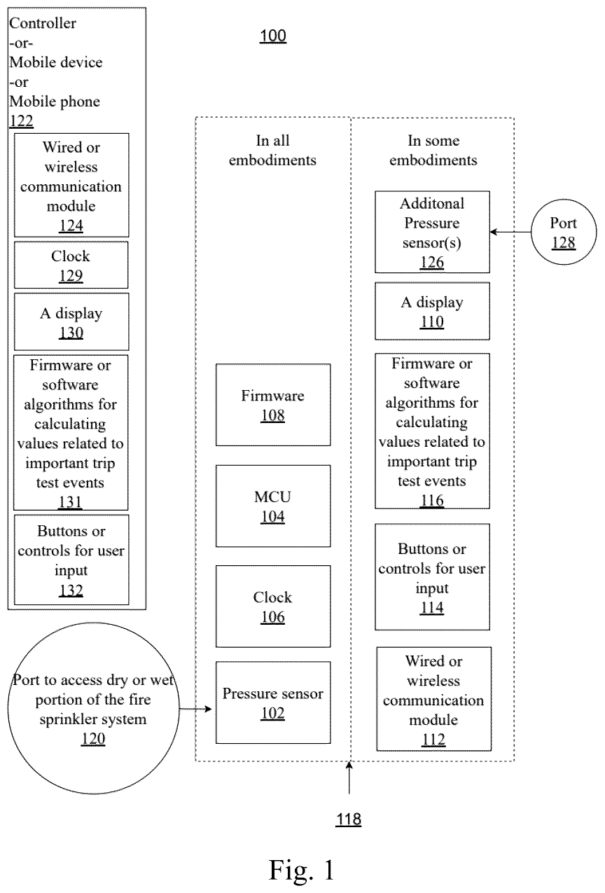

As shown in FIG. 1, a fire sprinkler system trip tester may comprise a pressure probe measurement system 100, according to various embodiments. The present inventors discovered and developed a pressure probe measurement system 100 capable of displaying and/or recording time and pressure events related to fire sprinkler trip testing. The pressure probe measurement system 100 comprises at least one pressure sensor 102, microcontroller unit (MCU) 104, clock 106, and firmware 108. In some embodiments, the pressure probe measurement system 100 may also include a display 110, wireless module for communication with external devices 112, buttons/controls 114 for user input and software/firmware algorithms 116 for calculating values related to important trip test events.

In a first aspect, a pressure probe measurement system 100 comprises a pressure measurement device 118 including a port 120 configured to removably access and fluidly connect with a dry or wet portion of a fire sprinkler system, a pressure sensor 102 fluidly connected to the port 120, and hardware (such as the MCU 104) electrically interconnected with the pressure sensor 102 and configured to measure pressure in the fire sprinkler system and to monitor changes in the pressure in the fire sprinkler system, the hardware including a time keeping device (as may be integral to MCU 104 and/or provided by a separate clock 106) and firmware 108 and/or software that allows a fire sprinkler technician to determine times when key events occur in a partial and/or full trip test of the fire sprinkler system.

The trip test (or partial trip test) and the full flow trip test (or full trip test), utilizing a single fire sprinkler technician may be prescribed pursuant to NFPA 25 (2023 edition) and future editions of NFPA 13.4.5.2.2 and 13.4.5.2.2.2, and various common types of fire sprinkler system valves and pipe network may be as described above. As an example, parking garages are common places where a dry pipe system is used in areas exposed to the elements and freezing but require sprinklers (especially in garages supporting electric cars). Such dry pipe system may include a valve (e.g., a clapper type valve) between the water supply and the dry pipe network (comprising the lines/conduit running to each sprinkler head). There is a mechanical advantage in the dry valve that typically allows the air pressure to be at a ratio of 1:5.5 PSI or 1:6 PSI as compared to the water pressure being held back, hence the jump in pressure measurable (and observable via pressure measurement gages or devices) on the dry side of the system when “the valve trips”. This jump in pressure is key to determining trip time/delivery time during a trip test of the fire sprinkler system.

Performing a trip test on such a dry system with just one person (fire sprinkler technician) is not supported using existing systems and methods. An example partial flow trip test (or partial trip test) typically includes the following steps: Throttle the sprinkler control valve to within 2.5 turns of being fully closed. Open the Inspectors test connection (typically located at the sprinkler head farthest away from the dry pipe valve) to release air pressure from the system. Record the time and air pressure at which the system (i.e., the dry pipe valve, e.g., clapper valve) trips. Compare the results with the previous tests and take appropriate corrective action if the trip time has increased. An example full flow trip test (or full trip test) typically includes the following steps: Keep the sprinkler control valve open fully. Complete a main drain test (which is described in greater detail below) to ensure adequate flow pressure into the system. Record air pressure. Open inspectors test connection. Record the time to trip the valve and the air pressure at the trip point. Record the time for the water to arrive at the inspector's test connection. Steady water flow should arrive within 60 seconds, for example. If it doesn't, a flushing investigation or a quick opening device may be required.

In a second aspect, the pressure measurement device 118 further comprises on board memory (such as provided with MCU 104 or additional componentry) and a clock 106, and wherein the system includes a controller (such as microcontroller 104 and/or controller 122) configured to permit the fire sprinkler technician to display pressure in the fire sprinkler system (for example via display 110 and/or via a display integral to the controller 122) and start and/or stop the time keeping device.

In a third aspect, the system 100 includes a controller 122 configured to wirelessly communicate (for example via wireless communication module 124 of the controller 122) and synchronize clocks (for example via clock 129 in the controller/mobile device/phone and clock 106 in the pressure measurement device 118) and measurements with the pressure measurement device 118 and to permit the fire sprinkler technician to display pressure in the fire sprinkler system (for example via display 110 and/or via a display integral to the controller 122) and start and/or stop the time keeping device.

In a fourth aspect, the system 100 allows the fire sprinkler technician to determine a full trip time during a full trip test of a dry sprinkler system. For example, the port 120 may be connected to the fire sprinkler dry pipe valve, with the pressure measurement device 118 configured to record pressure changes while the fire sprinkler technician opens and closes the inspector's port of the fire sprinkler system. The technician may thereafter return to the pressure measurement device 118 to stop the recording and view pressure changes versus time elapsed via display 110 and buttons or controls 114 and/or the display 110 comprising a graphical user interface with buttons or controls for user input displayed thereon, for completion of the full trip test of the dry sprinkler system.

In a fifth aspect, the system 100 allows the fire sprinkler technician to determine a partial trip time during a partial trip test of a dry sprinkler system. For example, the port 120 may be connected to the fire sprinkler dry pipe valve, with the pressure measurement device 118 configured to record pressure changes while the fire sprinkler technician opens and closes the inspector's port of the fire sprinkler system. The technician may thereafter return to the pressure measurement device 118 to stop the recording and view pressure changes versus time elapsed via display 110 and buttons or controls 114 and/or the display 110 comprising a graphical user interface with buttons or controls for user input displayed thereon, for determination of the valve trip time and pressure and completion of the partial trip test.

In a sixth aspect, the system 100 allows the fire sprinkler technician to monitor, record or remotely view air pressure of a dry sprinkler system during a trip test of the dry sprinkler system. For example, the port 120 may be connected to the fire sprinkler dry pipe valve, with the pressure measurement device 118 configured to wirelessly transmit air pressure measurement data during the trip test to a display or graphical user interface of the controller 122 (via wireless communication modules 112 and 124 of the pressure measurement device 118 and controller 122, respectively).

In a seventh aspect, the system 100 allows the fire sprinkler technician to determine a valve opening point during a trip test of a dry sprinkler system. For example, the port 120 may be connected to the fire sprinkler dry pipe valve, with the pressure measurement device 118 configured to record pressure changes while the fire sprinkler technician opens and closes the inspector's port of the fire sprinkler system. The technician may thereafter return to the pressure measurement device 118 to stop the recording and view pressure changes versus time elapsed via display 110 and buttons or controls 114 and/or the display 110 comprising a graphical user interface with buttons or controls for user input displayed thereon, for determination of the valve opening point during the trip test. In another example, the port 120 may be connected to the fire sprinkler dry pipe valve, with the pressure measurement device 118 configured to wirelessly transmit air pressure measurement data during the trip test to a display or graphical user interface of the controller 122 (via wireless communication modules 112 and 124 of the pressure measurement device 118 and controller 122, respectively). The technician may therefore monitor the air pressure during the trip test via the controller 122, for detection of the valve opening point (e.g., dry pipe valve tripping pressure and dry pipe valve tripping time) during the trip test.

In an eighth aspect, the system 100 allows the fire sprinkler technician to determine a valve opening point during a trip test of a dry sprinkler system. For example, the port 120 may be connected to the fire sprinkler dry pipe valve, with the pressure measurement device 118 configured to record pressure changes while the fire sprinkler technician opens and closes the inspector's port of the fire sprinkler system. The technician may thereafter return to the pressure measurement device 118 to synchronize the clocks and measurements of device 122 and device 118 and view pressure changes versus time elapsed via display 130 and buttons or controls 132 for determination of the valve opening point during the trip test. In another example, the port 120 may be connected to the fire sprinkler dry pipe valve, with the pressure measurement device 118 configured to wirelessly transmit air pressure measurement data during the trip test to a display or graphical user interface of the controller 122 (via wireless communication modules 112 and 124 of the pressure measurement device 118 and controller 122, respectively). The technician may therefore determine the trip times and pressure via the controller 122, for detection of the valve opening point (e.g., dry pipe valve tripping pressure and dry pipe valve tripping time) during the trip test.

In a ninth aspect, the system 100 allows the fire sprinkler technician to determine a compressor initiation point during a trip test of a dry sprinkler system. For example, the technician may monitor the air pressure during the trip test via a controller 122 in wireless communication with the pressure measurement device 118, for detection of a fall in air pressure after the inspector's port is opened, and detection of a subsequent leveling off and/or rise in air pressure when the compressor is activated (automatically in response to the fall in air pressure due to the inspector's port being opened by the technician).

In a tenth aspect, the system 100 allows the fire sprinkler technician to verify an accuracy of pressure measurements of analog gauges permanently installed on the fire sprinkler system. For example, the system 100 may comprise a pressure measurement device 118 having a display 110 whereupon pressure measurements may be displayed.

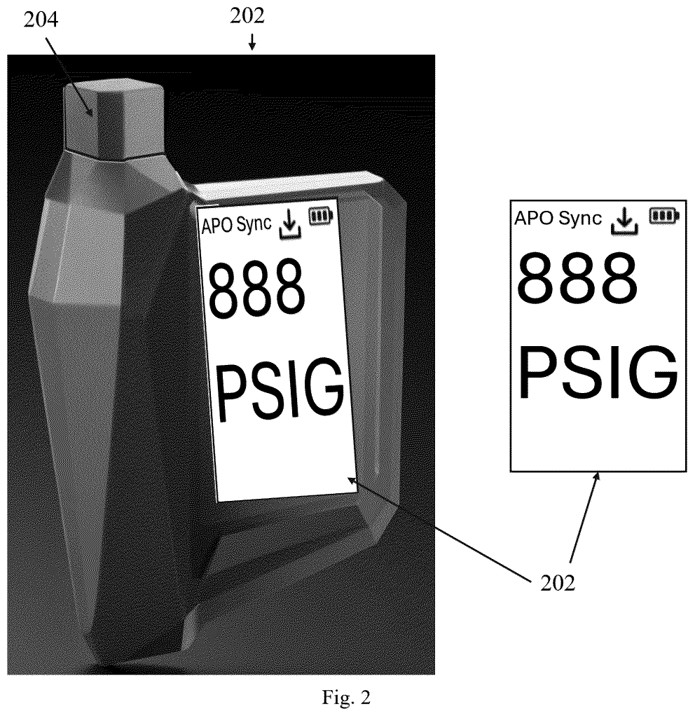

FIG. 2 illustrates a pressure measurement device 200 of the pressure probe measurement system 118 of FIG. 1, according to embodiments. This embodiment of the pressure measuring device 200 is a hand-held sized device having a display 202 (preferably comprising a graphical user interface that a fire sprinkler technician may use to control operation of the device 200). Alternatively, or in addition to a graphical user interface (GUI), the display 202 may be arranged so as to accommodate buttons or controls for user input. The device 200 includes a pressure sensor and a port 204 to access a dry or wet portion of a fire sprinkler system, or to removably access and fluidly connect with the dry or wet portion of the fire sprinkler system, or to removably access and fluidly connect with a conduit fluidly coupled to an analog gauge permanently installed on the fire sprinkler system.

The device 200 may be used to verify the accuracy of analog gauges permanently installed on the fire sprinkler system. For instance, the port 204 may be fluidly connected to an analog gauge installed on the dry pipe valve of the sprinkler system, or to conduit of the valve that is fluidly coupled directly to the analog gauge to be accuracy-verified/accuracy checked/calibrated. The fire sprinkler technician may use the procedures for fire sprinkler system gauge verification at 0 bar and working pressure pursuant to NFPA 25 (2023 edition) and future Editions of tests 13.2.4.2 & 13.2.4.3. The technician may compare the pressure readings from the permanently installed gauge and the pressure measurement device 200, and make manual adjustments to the permanently installed analog gauge to match the displayed pressure on the display 202 of the device 200.

In an eleventh aspect, the system 100 allows the fire sprinkler technician to monitor pressures during a hydrostatic test. Hydrostatic tests for standpipe and hose systems are performed pursuant to NFPA 25 (edition 2023) and future editions of tests 6.3.2.1. Such tests include for example, the following steps: Fill the dry pipe system with pressure. For example, the dry pipe system may be filled using an air compressor to 200 psi. Record pressure. Wait two hours. Measure again. The pressure should not decay beyond NFPA guidelines, indicating acceptable system integrity. Sign off system leak rate is acceptable. The system 100 allows for recording the pressure over time, for improved characterization of dry pipe pressure in the fire sprinkler system under test and to catch any fluctuations without the technician having to physically watch the pressure measurements in real-time. The pressure versus time data recorded by the pressure measurement device 118 (or 200) can be reviewed by the technician so as to catch any pressure drops and (automatic) corrections.

In a twelfth aspect, the system 100 allows the fire sprinkler technician to monitor pressures during a deluge system test. Monitoring of pressures for a deluge system is performed pursuant to NFPA 25 (edition 2023) and future editions of tests 10.3.3.4. Deluge systems operate whereby all the sprinklers go off at once when one is tripped. These systems do not have elements restricting/stopping water flow to any sprinkler, so when the system is either automatically or manually tripped, the whole system starts flowing. Testing a deluge system generally involves monitoring the pressures in the sprinklers farthest away from the deluge valve to ensure sufficient pressure is maintained for adequate spray during the test. The system 100 may include a pressure measurement device 118 coupled with a controller 122 (which may comprise a mobile phone with application software). The pressure measurement device 118 may be fluidly connected (via port 120) to a sprinkler head farthest from the deluge valve, and the technician may monitor the pressure at the sprinkler head via the graphical user interface of the mobile phone application 130.

In a thirteenth aspect, the system 100 allows the fire sprinkler technician to monitor pressures during a main drain test. A main drain test for fire sprinkler systems may be performed pursuant to NFPA 25 (edition 2023) and future editions of tests 13.2.2. The main drain test monitors supply pressure, requiring no more than a 10% reduction in full flow pressure. The main drain test is to make sure there is adequate flow into the system. A main drain test may, for example, include reading/measuring the static pressure (water supply pressure) (e.g., 55 psi). Then open the main drain valve (water flows out/outside). Read the pressure in supply line (e.g., 50 psi). This example shows a 10% reduction. This (i.e., the 50 psi) is the residual water pressure (with main drain open). The system 100 allows for the technician to log the supply pressure throughout the main drain test and later analyze a resulting graph of pressure over time.

In a fourteenth aspect, the system 100 allows the fire sprinkler technician to monitor pressures during a pre-action system pressure test. A pre-action test for fire sprinkler systems may be performed pursuant to NFPA 25 (edition 2023) and future editions of tests 13.4.3.2.6. The system 100 may be configured as previously described, to monitor for a decay in pressure due to leaks through, for example, the dry system.

In a fifteenth aspect, the system 100 includes a controller configured to permit the fire sprinkler technician to display pressure in the fire sprinkler system and start and/or stop the time keeping device, and wherein the pressure measurement device and/or the controller allows the fire sprinkler technician to download information displayed and/or stored on the pressure measurement device and/or the controller to a computer.

In a sixteenth aspect, the system 100 includes a controller configured to permit the fire sprinkler technician to display pressure in the fire sprinkler system and start and/or stop the time keeping device, and wherein the pressure measurement device and/or the controller allows the fire sprinkler technician to transmit information displayed and/or stored on the pressure measurement device and/or the controller to a mobile device.

In a seventeenth aspect, the controller 122 is a mobile phone.

In an eighteenth aspect, the system 100 comprises one or more additional pressure sensors (such as additional sensor 126), each additional pressure sensor including an additional pressure sensor port (such as additional pressure sensor port 128) configured to removably access and fluidly connect with the dry or wet portion of the fire sprinkler system, and wherein the controller is configured to permit the fire sprinkler technician to display pressure measured by each additional pressure sensor.

An example full trip test may include the following parameters: Dry System Pressure. Water Supply Pressure. Start (Time of opening inspector's test connection). Technician Logs time. Stop (Time at which water flows steadily at the test connection). Technician Stops log. These are enabled by aspects and features of the system 100. For example, dry system pressure may be measured, monitored, and recorded via connection with port 120 of a pressure measurement device 118. Simultaneously, water supply pressure may be measured, monitored, and recorded via connection with an additional pressure sensor 126 via additional pressure sensor port 128. Start and stop times may be captured by the technician via inputs to the controller 122 and/or to a display 110 or 130 (with graphical user interface) of the (hand-held, sized) pressure measurement device 118 (or, for example, the device 200 in FIG. 2) or 122.

An example full trip test may include the following calculations/judgements: Dry pipe valve tripping pressure. Dry pipe valve tripping time. Calculation based on data or manual/visual addition/judgement. Trip time at test port. Full trip time. These are enabled by previously described aspects and features of the system 100. For example, dry pipe valve tripping pressure and dry pipe valve tripping time may be determined as described above with respect to the seventh aspect.

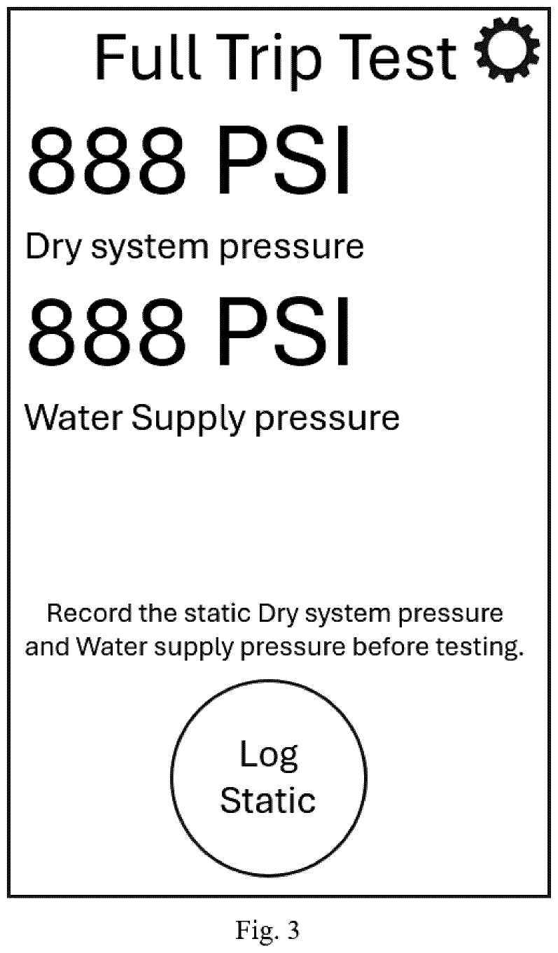

FIGS. 3-9 illustrate a graphical user interface (GUI) display of various parameters, measurements, user prompts (for a technician), user inputs for logging static measurements, starting and stopping a trip timer, and displaying a range of trip testing related parameters (including initial static dry system and water supply pressures, dynamically changing (real-time) water supply pressure, dynamically changing (real-time) air (dry pipe) pressure, dry pipe valve trip time, dry pipe valve tripping pressure, inspector's test port trip time, time to clear water, and drain time), for an example full trip test, which may be displayed on, for example, a display such as display 110, or on a controller 122 (or a mobile device or mobile phone comprising controller 122), and/or a display of a hand-held sized pressure measurement device such as the display 202 of device 200 shown in FIG. 2.

FIG. 3 is an illustration of a GUI display wherein the display shows dry system pressure and water supply pressure. Press “log static” button on GUI display to record the static dry system pressure and water supply pressure before testing.

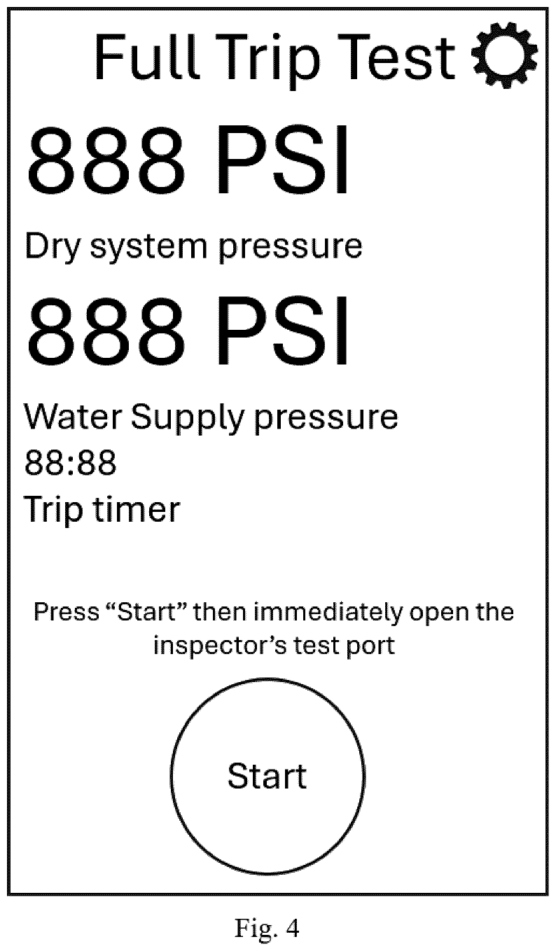

FIG. 4 is an illustration of a GUI display showing the following: Press “start” button on GUI display, then immediately open the inspector's test port. Display shows data measurements and button with label on button and/or directions just above button. Display shows (in addition to dry system pressure and water supply pressure) Trip timer (running).

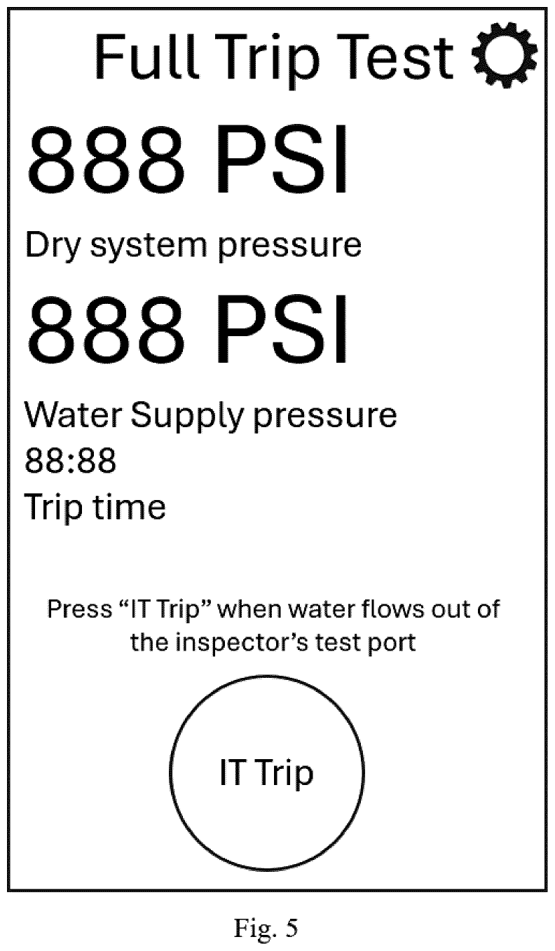

FIG. 5 is an illustration of a GUI display showing the following: Press “IT Trip” when water flows out of the inspector's test port. Display shows (additionally) Trip time.

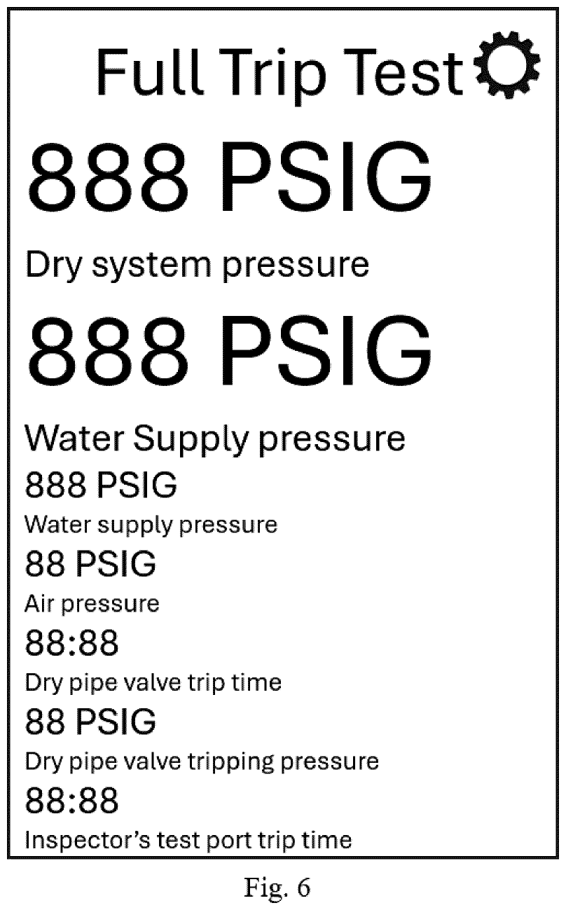

FIG. 6 is an illustration of a GUI display showing the following: Display screen shows dry system pressure in PSIG, water system pressure in PSIG, air pressure, dry pipe valve trip time, dry pipe valve tripping pressure, inspector's test port trip time.

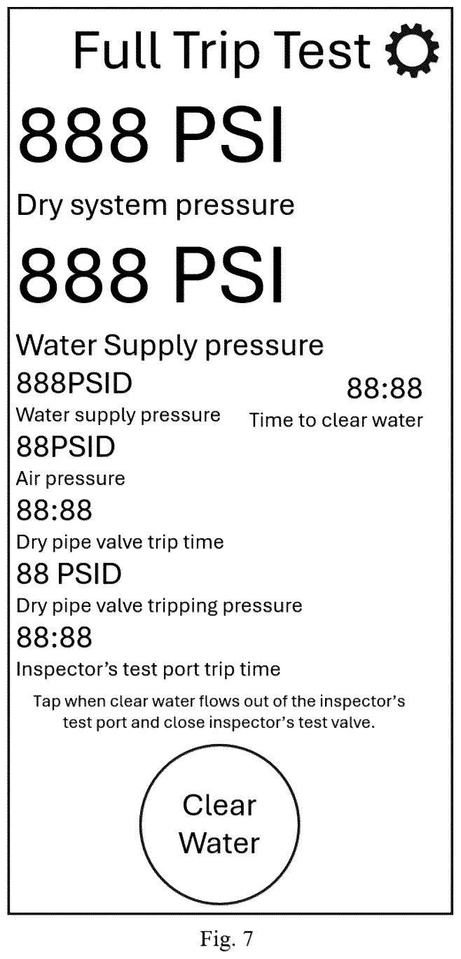

FIG. 7 is an illustration of a GUI display showing the following: Tap “clear water” when clear water flows out of inspector's test port, and close inspector's test valve. Display shows (in addition to all prior) Time to clear water.

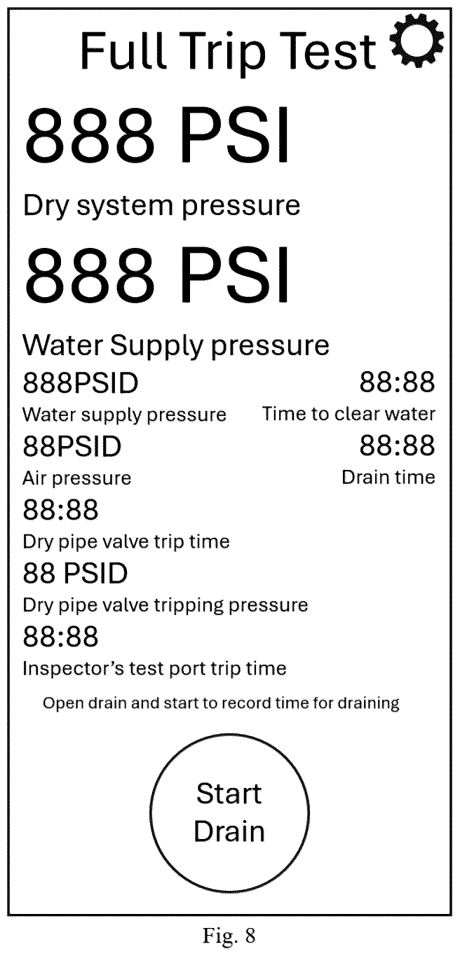

FIG. 8 is an illustration of a GUI display showing the following: Open drain and start to record time for draining. Button indicates “Start drain”. Display shows (additionally) Drain time (seconds) shows as running timer.

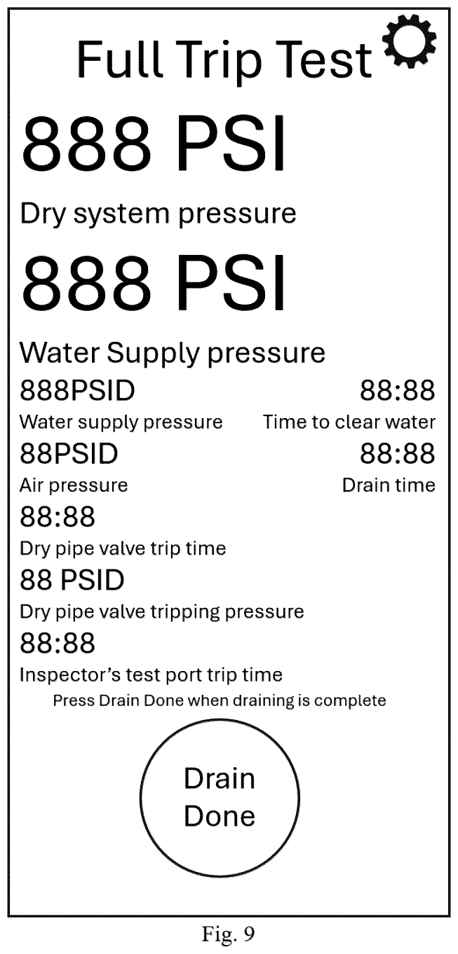

FIG. 9 is an illustration of a GUI display showing the following: Press Drain Done when draining is complete.

In an eighteenth aspect, a method of using the pressure measurement system 100 comprises: connecting the port of the pressure measurement device to the dry portion of the fire sprinkler system under test; recording a static dry system pressure and a static water supply pressure of the fire sprinkler system using a graphical user interface of the controller prior to starting a trip test of the fire sprinkler system; starting a trip timer of the time keeping device via the graphical user interface of the controller when an inspector's test port of the fire sprinkler system is opened, and displaying a running elapsed time of the trip timer on the graphical user interface; using the graphical user interface of the controller, recording a time elapsed between start of the trip timer and a trip point of a dry pipe valve introducing water from the wet portion of the fire sprinkler to the dry portion of the fire sprinkler system, and recording a dry pipe tripping pressure at the trip point of the dry pipe valve; and stopping the trip timer of the time keeping device via the graphical user interface of the controller when water flows out of the inspector's test port, and displaying an elapsed time of the trip timer on the graphical user interface as an inspector's port trip time.

In a nineteenth aspect, the method of using the system 100 further comprises: starting a timer of the time keeping device via the graphical user interface of the controller when a drain valve is opened; and stopping the timer of the time keeping device via the graphical user interface of the controller when draining is complete, and displaying an elapsed time of the timer as a drain time for the fire sprinkler system under test.

In a twentieth aspect, a method of using the pressure measurement system 100 comprises: connecting the port of the pressure measurement device to the dry portion of the fire sprinkler system under test; connecting the additional pressure sensor port of one of the one or more additional pressure sensors to a water supply portion of the fire sprinkler system under test; recording a static dry system pressure and a static water supply pressure of the fire sprinkler system using a graphical user interface of the controller 122 prior to starting a trip test of the fire sprinkler system; during the trip test, displaying and/or logging real-time water supply pressure and real-time dry system pressure on the graphical user interface of the controller 122, and storing the real-time water supply pressure and the real-time dry system pressure during the trip test for later viewing on the graphical user interface by the fire sprinkler technician; starting a trip timer of the time keeping device via the graphical user interface of the controller when an inspector's test port of the fire sprinkler system is opened, and displaying a running elapsed time of the trip timer on the graphical user interface; using the graphical user interface of the controller, recording a time elapsed between start of the trip timer and a trip point of a dry pipe valve introducing water from the wet portion of the fire sprinkler to the dry portion of the fire sprinkler system, and recording a dry pipe tripping pressure at the trip point of the dry pipe valve; and stopping the trip timer of the time keeping device via the graphical user interface of the controller when water flows out of the inspector's test port, and displaying an elapsed time of the trip timer on the graphical user interface as an inspector's port trip time.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. A pressure probe measurement system comprising:
a pressure measurement device including a port configured to removably access and fluidly connect with a dry or wet portion of a fire sprinkler system, a pressure sensor fluidly connected to the port, and hardware electrically interconnected with the pressure sensor and configured to measure pressure in the fire sprinkler system and to monitor changes in the pressure in the fire sprinkler system, the hardware including a time keeping device and firmware and/or software that allows a fire sprinkler technician to determine times when key events occur in a trip test and/or full flow trip test of the fire sprinkler system.

2. The system of claim 1, wherein the system includes a controller, the controller having its own clock and an interface that allows the technician to record times of events and then synchronize the times of those events to pressure measurements of the pressure measurement device to determine the key events that occur in the trip test and/or full flow trip test of the fire sprinkler system.

3. The system of claim 1, wherein the pressure measurement device further comprises on board memory and a clock, and wherein the system includes a controller configured to permit the fire sprinkler technician to display pressure in the fire sprinkler system and start and/or stop the time keeping device.

4. The system of claim 1, wherein the system includes a controller configured to wirelessly communicate with the pressure measurement device and to permit the fire sprinkler technician to display pressure in the fire sprinkler system and start and/or stop the time keeping device.

5. The system of claim 1, wherein the system allows the fire sprinkler technician to determine a trip time during a trip test of a dry sprinkler system.

6. The system of claim 1, wherein the system allows the fire sprinkler technician to determine a full flow trip time during a full flow trip test of a dry sprinkler system.

7. The system of claim 1, wherein the system allows the fire sprinkler technician to monitor, record or remotely view air pressure of a dry sprinkler system during a trip test of the dry sprinkler system.

8. The system of claim 1, wherein the system allows the fire sprinkler technician to determine a valve opening point during a trip test of a dry sprinkler system.

9. The system of claim 1, wherein the system allows the fire sprinkler technician to determine a compressor initiation point during a trip test of a dry sprinkler system.

10. The system of claim 1, wherein the system allows the fire sprinkler technician to verify an accuracy of pressure measurements of analog gauges permanently installed on the fire sprinkler system.

11. The system of claim 1, wherein the system allows the fire sprinkler technician to monitor pressures during a hydrostatic test.

12. The system of claim 1, wherein the system allows the fire sprinkler technician to monitor pressures during a deluge system test.

13. The system of claim 1, wherein the system allows the fire sprinkler technician to monitor pressures during a main drain test.

14. The system of claim 1, wherein the system allows the fire sprinkler technician to monitor pressures during a pre-action system pressure test.

15. The system of claim 1, wherein the system includes a controller configured to permit the fire sprinkler technician to display pressure in the fire sprinkler system and start and/or stop the time keeping device, and wherein the pressure measurement device and/or the controller allows the fire sprinkler technician to download information displayed and/or stored on the pressure measurement device and/or the controller to a computer.

16. The system of claim 1, wherein the system includes a controller configured to permit the fire sprinkler technician to display pressure in the fire sprinkler system and start and/or stop the time keeping device, and wherein the pressure measurement device and/or the controller allows the fire sprinkler technician to transmit information displayed and/or stored on the pressure measurement device and/or the controller to a mobile device.

17. The system of claim 2, wherein the controller is a mobile phone.

18. The system of claim 17, wherein the system comprises one or more additional pressure sensors, each additional pressure sensor including an additional pressure sensor port configured to removably access and fluidly connect with the dry or wet portion of the fire sprinkler system, and wherein the controller is configured to permit the fire sprinkler technician to display pressure measured by each additional pressure sensor.

19. A method of using the pressure measurement system of claim 1, the method comprising:
connecting the port of the pressure measurement device to the dry portion of the fire sprinkler system under test;
recording a static dry system pressure and a static water supply pressure of the fire sprinkler system using a graphical user interface of the controller prior to starting a trip test of the fire sprinkler system;
starting a trip timer of the time keeping device via the graphical user interface of the controller when an inspector's test port of the fire sprinkler system is opened, and displaying a running elapsed time of the trip timer on the graphical user interface;
using the graphical user interface of the controller, recording a time elapsed between start of the trip timer and a trip point of a dry pipe valve introducing water from the wet portion of the fire sprinkler to the dry portion of the fire sprinkler system, and recording a dry pipe tripping pressure at the trip point of the dry pipe valve; and
stopping the trip timer of the time keeping device via the graphical user interface of the controller when water flows out of the inspector's test port, and displaying an elapsed time of the trip timer on the graphical user interface as an inspector's port trip time.

20. A method of using the pressure measurement system of claim 17, the method comprising:
connecting the port of the pressure measurement device to the dry portion of the fire sprinkler system under test;
connecting the additional pressure sensor port of one of the one or more additional pressure sensors to a water supply portion of the fire sprinkler system under test;
recording a static dry system pressure and a static water supply pressure of the fire sprinkler system using a graphical user interface of the controller prior to starting a trip test of the fire sprinkler system;
during the trip test, displaying real-time water supply pressure and real-time dry system pressure on the graphical user interface of the controller, and storing the real-time water supply pressure and the real-time dry system pressure during the trip test for later viewing on the graphical user interface by the fire sprinkler technician;
starting a trip timer of the time keeping device via the graphical user interface of the controller when an inspector's test port of the fire sprinkler system is opened, and displaying a running elapsed time of the trip timer on the graphical user interface;
using the graphical user interface of the controller, recording a time elapsed between start of the trip timer and a trip point of a dry pipe valve introducing water from the wet portion of the fire sprinkler to the dry portion of the fire sprinkler system, and recording a dry pipe tripping pressure at the trip point of the dry pipe valve; and
stopping the trip timer of the time keeping device via the graphical user interface of the controller when water flows out of the inspector's test port, and displaying an elapsed time of the trip timer on the graphical user interface as an inspector's port trip time.
